(19) United States
(12) Patent Application Publication
(10) Pub. No.: US 2026/0370176 A1
(43) Pub. Date: Nov. 19, 2026

(54) Frames for Photovoltaic Modules

(71) Applicant: Enstall US, Inc., Walnut Creek, CA (US)

(72) Inventors: Jon Ash, Phoenix, AZ (US); Roger Pedlar, Phoenix, AZ (US); Duane Menton, Vallejo, CA (US); Joseph Armano, Andover, MA (US); Lori Brock, Ipswich, MA (US); Jan-Floris de Graaf, Schalkhaar, Overijssel (NL); Bryan Chidester, Glendale, AZ (US)

(21) Appl. No.: 19/126,051

(22) PCT Filed: Nov. 1, 2023
(86) PCT No.: PCT/US2023/036626

§ 371 Date: Apr. 30, 2025

Related U.S. Application Data
(60) Provisional application No. 63/421,319, filed on Nov. 1, 2022.

(51) Int. Cl. H02S 20/20

(52) U.S. Cl. CPC H02S 20/20

(57) ABSTRACT

A frame for a photovoltaic module may include a base portion having an outer lip and a bottom surface; at least one leg extending from the base portion; and a panel support portion extending from the at least one leg, the panel support portion configured to secure a solar panel therein. The outer lip and the at least one leg may define a cavity configured to receive a first portion of a solar panel mounting element therein.

### CROSS REFERENCE TO RELATED APPLICATIONS

This application claims priority to U.S. Provisional Application No. 63/421,319, filed Nov. 1, 2022 and titled Frame for Photovoltaic Modules, the disclosure of which is hereby incorporated by reference in its entirety.

### BACKGROUND OF THE INVENTION

### Field of the Invention

The present disclosure relates to frames for photovoltaic modules.

### Description of Related Art

Photovoltaic modules are often used in large, multiple-module arrays. Some of these systems are used on buildings where space may be limited, creating a need to maximize the amount of space occupied by the modules. Such an arrangement creates the need to easily mount the modules within their frames so that the module and frame combination can be used effectively and efficiently within the system. Therefore, it is desirable to have frames for photovoltaic modules that promote a quick installation while efficiently using space and minimizing interference with modules and frames that are already installed or yet to be installed.

### SUMMARY OF THE INVENTION

A frame for a photovoltaic module may include a base portion having an outer lip and a bottom surface; at least one leg extending from the base portion; and a panel support portion extending from the at least one leg, the panel support portion configured to secure a solar panel therein. The outer lip and the at least one leg may define a cavity configured to receive a first portion of a solar panel mounting element therein.

The at least one leg may include two legs, and the two legs, the base portion, and the panel support portion may define a hollow cavity. The two legs may extend between the base portion and the panel support portion at an angle, and the angle may or may not be orthogonal to the base portion or the panel support portion. The base portion may further include an inner flange extending in a direction opposite that of the outer lip. The outer lip may be offset from the inner flange. The offset may define a space between the outer lip and a surface on which the frame is mounted. An end of the inner flange may be rounded. The outer lip may be triangular in shape.

A first leg may extend from the base portion so as to define an orthogonal angle with the base portion, and a second leg may extend from the base portion so as to define a non-orthogonal angle with the base portion. The outer lip may be curved as it extends from the base portion. The outer lip may extend from the base portion proximate the second leg. The outer lip defines an acute angle with the second leg. The base portion may include a center portion, and the outer lip may extend from the center portion. The base portion may have a first thickness, and the outer lip may have a second thickness that is larger than the first thickness. The frame may be extruded. The frame may include roll formed steel. The entirety of the frame may be formed of roll formed steel. A starting point of the roll formed steel may be proximate a sidewall and a top wall of the panel support portion, and an end point of the roll formed steel may be proximate an end point of a panel support surface of the panel support portion.

A solar panel array may be mounted using the steps of: tilting the frame so as to align the first portion of the solar panel mounting element within the cavity; and rotating the frame so that the bottom surface of the base portion contacts a second portion of the solar panel mounting element. Upon rotation of the frame, the first portion of the solar panel mounting element fully engages with the cavity.

In some aspects or embodiments, the present disclosure can be characterized by the following clauses.
Clause 1. A frame for a photovoltaic module, the frame comprising: a base portion comprising an outer lip and a bottom surface; at least one leg extending from the base portion; and a panel support portion extending from the at least one leg, the panel support portion configured to secure a solar panel therein, wherein the outer lip and the at least one leg define a cavity configured to receive a first portion of a solar panel mounting element therein.
Clause 2. The frame of claim 1, wherein the at least one leg comprises two legs, and wherein the two legs, the base portion, and the panel support portion define a hollow cavity.
Clause 3. The frame of clause 2, wherein the two legs extend between the base portion and the panel support portion at an angle, and wherein the angle is not orthogonal to the base portion or the panel support portion.
Clause 4. The frames of any of clauses 1-3, wherein the base portion further comprises an inner flange extending in a direction opposite the initial extending direction of the outer lip.
Clause 5. The frames clause 4, wherein the outer lip is offset from the inner flange.
Clause 6. The frame of clause 5, wherein the offset defines a space between the outer lip and a surface on which the frame is mounted.
Clause 7. The frame of clause 6, wherein an end of the inner flange is rounded.
Clause 8. The frame of clause 7, wherein the outer lip is triangular in shape.
Clause 9. The frame of any of clauses 1-8, wherein the outer lip is triangular in shape.
Clause 10. The frame of Clause 2 or 3, wherein a first leg extends from the base portion so as to define an orthogonal angle with the base portion, and wherein a second leg extends from the base portion so as to define a non-orthogonal angle with the base portion.
Clause 11. The frame of clause 10, wherein the outer lip is curved as it extends from the base portion.
Clause 12. The frame of clause 11, wherein the outer lip extends from the base portion proximate the second leg.
Clause 13. The frame of clause 12, wherein the outer lip defines an acute angle with the second leg.
Clause 14. The frame of any of clauses 1-13, wherein the base portion comprises a center portion, and the outer lip extends from the center portion, and wherein the base portion has a first thickness, and the outer lip has a second thickness that is larger than the first thickness.
Clause 15. The frame of clause 2 or 3, wherein the two legs extend between the base portion and the panel support portion so as to define an orthogonal angle with the base portion.
Clause 16. The frame of any of clauses 1-15, wherein the frame is extruded.
Clause 17. The frame of any of clauses 1-16, further comprising roll formed steel.
Clause 18. The frame of clause 17, wherein the entire frame is formed of roll formed steel.
Clause 19. The frame of clause 18, wherein a starting point of the roll formed steel is proximate a sidewall and a top wall of the panel support portion, and wherein an end point of the roll formed steel is proximate an end point of a panel support surface of the panel support portion.
Clause 20. A method of mounting the frame of clause 1 in a solar panel array, the method comprising the steps of: tilting the frame so as to align the first portion of the solar panel mounting element within the cavity; and rotating the frame so that the bottom surface of the base portion contacts a second portion of the solar panel mounting element, wherein upon rotation of the frame, the first portion of the solar panel mounting element fully engages with the cavity.

### BRIEF DESCRIPTION OF THE DRAWINGS

FIG. 1 is a perspective view of a frame for a photovoltaic module according to one embodiment or aspect of the present disclosure;

FIG. 2 is an end view of the frame of FIG. 1;

FIG. 3 is a perspective view of the frame of FIG. 1 being mounted to a clamp used in a solar panel system;

FIG. 4 is a front view of the frame of FIG. 1 being mounted to a clamp used in a solar panel system;

FIG. 5 is a front view of two frames of FIG. 1 mounted to a clamp used in a solar panel system;

FIG. 6 is a front view of a frame for a photovoltaic module according to another embodiment or aspect of the present disclosure;

FIG. 7 is a front view of a frame for a photovoltaic module according to another embodiment or aspect of the present disclosure;

FIG. 8 is a front view of a frame for a photovoltaic module according to another embodiment or aspect of the present disclosure;

FIG. 9 is a front view of a frame for a photovoltaic module according to another embodiment or aspect of the present disclosure;

FIG. 10 is a front view of a frame for a photovoltaic module according to another embodiment or aspect of the present disclosure;

FIG. 11 is a front view of a frame for a photovoltaic module according to another embodiment or aspect of the present disclosure;

FIG. 12 is a front view of a frame for a photovoltaic module according to another embodiment or aspect of the present disclosure;

FIG. 13 is a front view of a frame for a photovoltaic module according to another embodiment or aspect of the present disclosure;

FIG. 14 is a front view of a frame for a photovoltaic module according to another embodiment or aspect of the present disclosure;

FIG. 15 is a front view of a frame for a photovoltaic module according to another embodiment or aspect of the present disclosure;

FIG. 16 is a front view of a frame for a photovoltaic module according to another embodiment or aspect of the present disclosure; and

FIG. 17 is a front view of a frame for a photovoltaic module according to another embodiment or aspect of the present disclosure.

### DESCRIPTION OF THE INVENTION

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the disclosure as shown in the drawing figures and are not to be considered as limiting as the disclosure can assume various alternative orientations.

The terms “first”, “second”, and the like are not intended to refer to any particular order or chronology, but refer to different conditions, properties, or elements.

The term “includes” is synonymous with “comprises”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular” or “substantially perpendicular” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

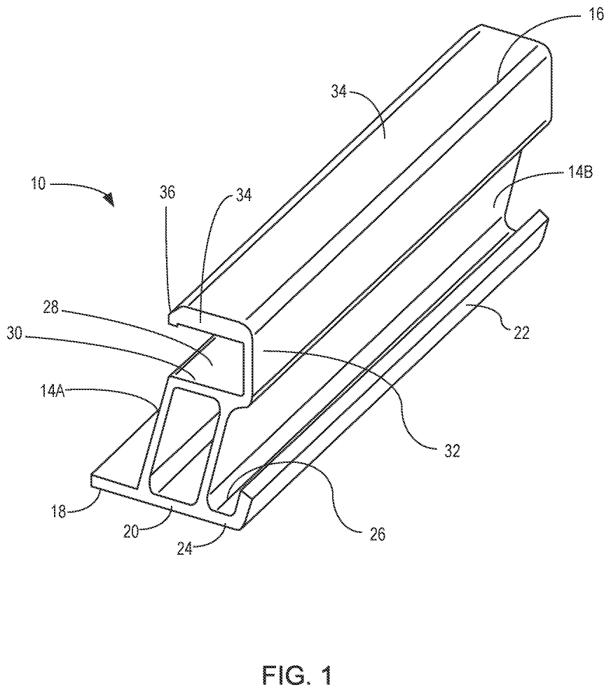

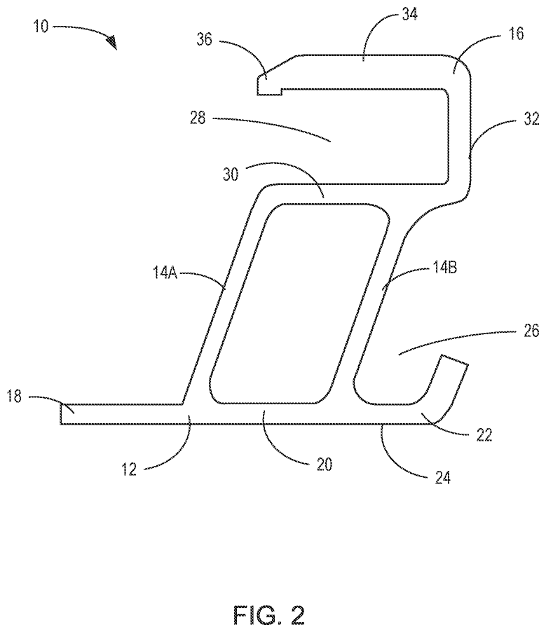

With reference to FIGS. 1 and 2 a solar panel frame 10 according to one embodiment or aspect of the present disclosure is shown. The solar panel frame 10 includes a base 12, legs 14A, 14B extending from the base 12, and a panel support portion 16 extending from the legs 14A, 14B. Although two legs 14A, 14B are shown, one having ordinary skill in the art will appreciate that any number of legs may be used so long as the panel support portion 16 is adequately supported above the base 12 to allow for solar panel used in conjunction with the frame 10 to be properly operated and supported.

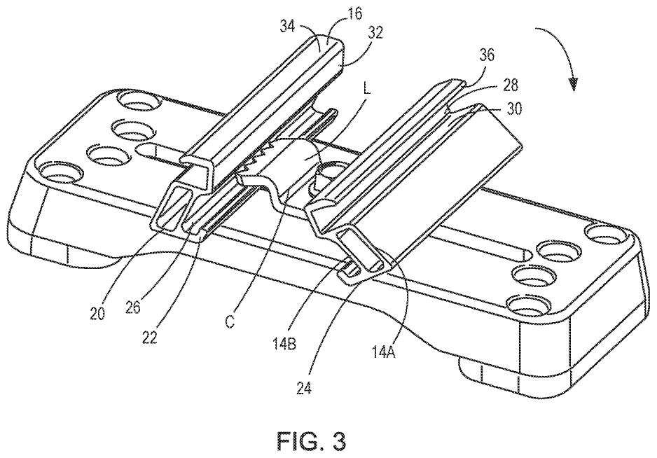

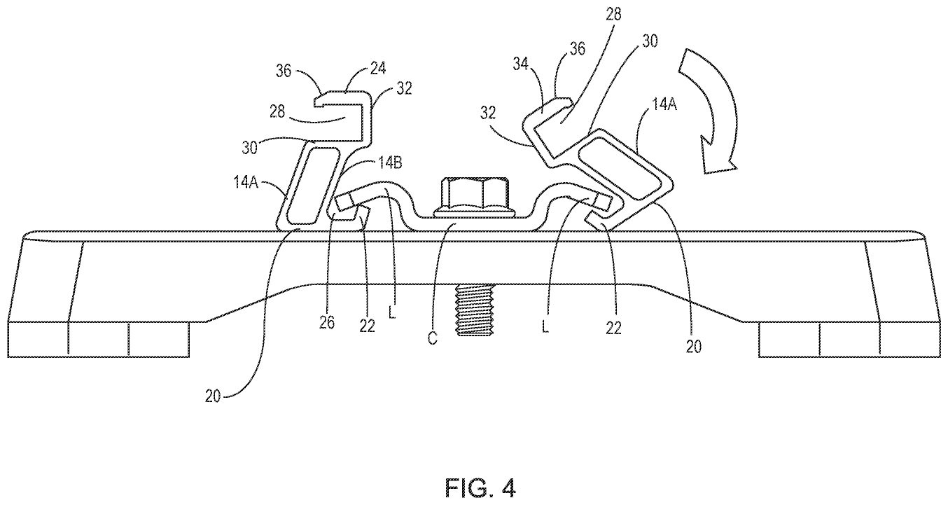

The base 12 includes an inner flange 18, a center portion 20, and an outer lip 22. As shown, the inner flange 18, center portion 20, and outer lip 22 are integral with each other and define a flat bottom surface 24, on which the frame 10 may rest when in use. The inner flange 18 extends from the center portion 20 in the same direction as a solar panel would extend from the solar panel support portion 16. The inner flange 18 may be used to organize additional elements relating to the solar panel, such as wires. Additional shapes and embodiments of the inner flange 18 will be described in greater detail below. The outer lip 22 extends from the center portion 20 in a direction that is at least initially opposite that of the inner flange 18. The outer lip 22 also includes a portion that tilts upward relative to the bottom surface 24 of the center portion 20, which is generally in the direction of the panel support portion 16. As shown, the outer lip 22 tilts upward at approximately a forty-five degree angle, although other angles may be used. As shown in later figures, outer lips extend upwards substantially orthogonally to the center portion 20 of the base 12. The outer lip 22 is shaped so that it may engage with a mounting lip L on a mounting clamp C as shown in FIGS. 3-5. The outer lip 22 and one of the legs 14B define a clamp cavity 26 that receives the mounting lip L of the mounting clamp C therein. The engagement between the base 12 and the mounting clamp C will be described in greater detail below.

Extending upward from the center portion 20 are the legs 14A, 14B. The legs 14A, 14B support the panel support portion 16. As shown, the legs 14A, 14B are tilted at an angle relative the center portion 20. Such an arrangement allows for the panel support portion 16 to be offset from the center portion 20 in order to accommodate a solar panel within the solar panel array. Depending on the size of the solar panel to be used with the frame 10, the tilt angle of the legs 14A, 14B may be adjusted. In some embodiments described below, the legs 14A, 14B will not be tilted relative to the center portion 20. Instead, the legs 14A, 14B may extend straight upward relative to the center portion 20, defining an orthogonal angle with the center portion 20. It is also contemplated that one leg may be tilted while the other extends straight from the center portion 20.

The panel support portion 16 takes a generally reversed C-shape and rests on the legs 14A, 14B. The panel support portion 16 defines a panel cavity 28 therein. The panel support portion 16 includes a panel support surface 30 extending across the ends of the legs 14A, 14B and configured to support the solar panel thereon. The legs 14A, 14B, center portion 20, and panel support surface 30 define a hollow cavity HC extending along the entire length of the solar panel frame 10. The legs 14A, 14B may also be tilted relative to the panel support surface or define an orthogonal angle with the surface 30. Extending upward from the panel support surface 30 is a sidewall 32 that acts as a stop to contain the solar panel within the cavity 28. The sidewall 32 extends inward the same distance as the outer lip 22. Extending from the sidewall 32 substantially parallel to the panel support surface 30 is a top wall 34. Extending downward from the top wall is a lip 36 that engages with the solar panel in order to retain the panel within the cavity 28. The lip 36 may be shaped to frictionally engage all of the solar panel, or the solar panel may include a receiving slot or other feature that the lip 36 is designed to specifically engage with other features on the solar panel.

The size and shape of the panel support portion 16 may be adjusted according to the shape of the solar panel relative to the array in which the panel is to be placed. For example, the elements of the panel support portion 16 may be larger than shown to support a large solar panel, and the panel support portion 16 may be located at different points in the frame 10 relative to the legs 14A, 14B in order to ensure the solar panel held within the cavity 28 fits adjacent to other panels in the array. The panel support portion 16 may also be disposed at varying heights relative to the bottom surface 24. In some instances, the panel support portion 16 may be tilted at an angle relative to the bottom surface 24 so that the solar panels mounted within the cavity are also tilted. The panel support portion 16 may also take shapes other than the C-shape shown, so long as the solar panel can be adequately secured within the cavity 28.

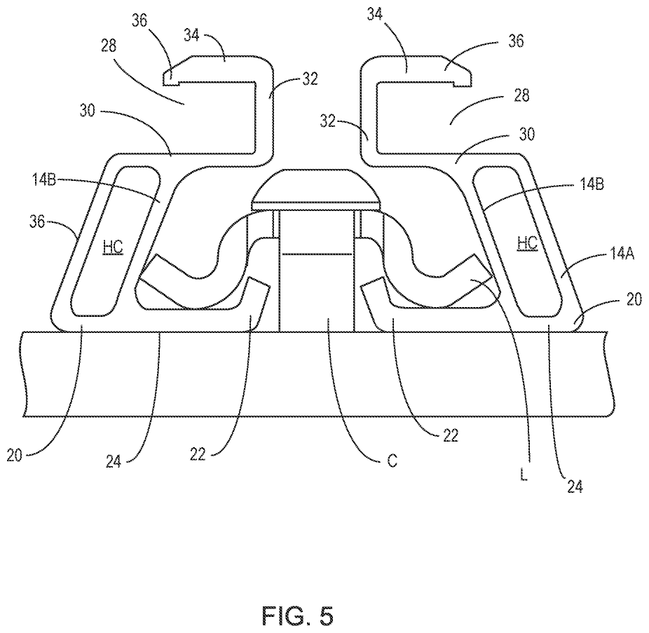

With reference to FIGS. 3-5, a method of mounting the frame 10 to a clamp C will now be described. The clamp C is intended to be exemplary to generally describe the mounting process from the perspective of the frame 10. Specific mounting clamps that can be used with the frames discussed in this section will be discussed later. One will also appreciate that the frame 10 may be mounted to the leg of another frame or to a mounting rail in a similar manner. First, the frame 10 is tilted at an angle so that at least the end of the mounting lip L of the mounting clamp is received within the clamp cavity 26. Next, the frame 10 is rotated downward in the direction of the element or feature onto which the mounting clamp C is connected. This rotation occurs until the bottom surface 24 of the frame 10 fully contacts the base of the mounting element or other feature onto which the clamp C is connected. During rotating the frame 10, a snap or a clicking sound may occur as a result of contact between the mounting lip L and the tilted outer lip 22. Such a sound may be indicative of an engagement between the mounting lip L and the outer lip 22 and clamp cavity 26. Once engaged, the frame 10 can slide along mounting element in a direction into or out of the page when viewing FIG. 5, in order to adjust its placement within the solar panel array. When the mounting lip L is held within the clamp cavity 26, and the bottom surface 24 fully contacts the mounting element, the mounting lip L may apply a downward force to the frame 10 that serves to secure the frame 10 in place. Attachment feet may also be integrated with a frame, thereby allowing a second frame to clip or snap onto a foot at one end, while the frame at an opposing end of the solar panel includes another integrated attachment foot in another embodiment of the frame modules discussed herein.

Referring still to FIGS. 1-5, but with consideration for frames and clamps yet to be discussed, the benefits of such a mounting arrangement will now be described. The upward force resulting from the rotation of the frame 10 against the clamp C, and specifically against the mounting lips L allows for a unique mounting process and methodology. The panel frames 10 may be installed into the clamps C after the clamps C are securely fixed and connected to the rails R or other support structures. This eliminates the need to place the panels in the correct location on the support structures or rails R before tightening the clamps C. This allows easier access to the clamps C for tightening because the installer no longer needs to reach over the panel to tighten the clamps C. Additionally, the mounting lips L may be preset at a height above the rail R or other support structure such that the clamp C can be slidingly moved along the support structure or rail R toward a frame 10 that is already in its desired final location on the support structure or rail R. Here, an installer slides the clamp C along the support structure or rail R until one of the mounting lips L extends into the clamp cavity 26. Then another panel can be installed and rotated into the clamp C against the currently unused mounting lip L as described above. This process can be repeated until all adjacent panels in a row or column have been installed. This additional methodology can improve the ease of installation, reduce the time and labor required to complete the installation, eliminate the use of tools to tighten fasteners and minimize the small parts and loose fasteners that can easily fall off the roof or other mounting surface and become lost. The aforementioned mounting process will be similar or identical for the other frames and mounting clamps described below.

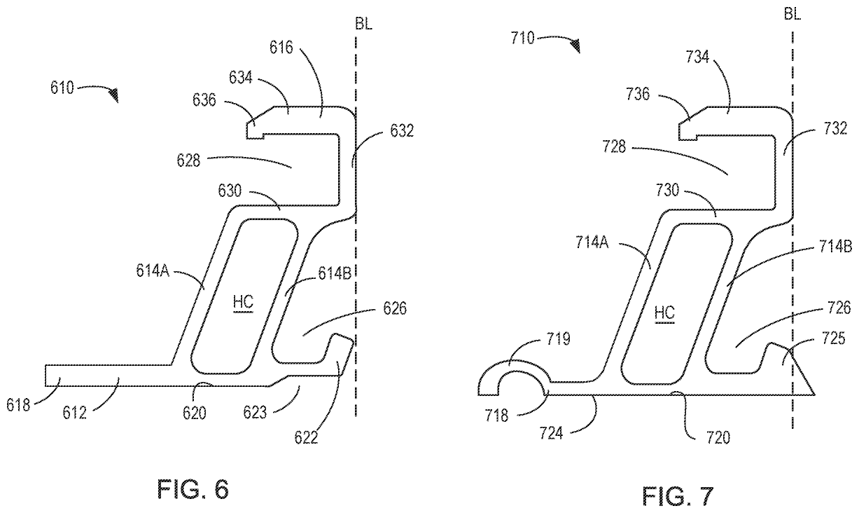

FIGS. 6-17 show additional solar panel frame embodiments, and each will be briefly discussed. The features that are the same in each embodiment will have similar reference numerals. The discussion of each frame will focus on the differences between that frame and frame 10. Based on the figures and the similar functionalities of each solar panel frame, the structure of each frame will be apparent.

FIG. 6 shows a frame 610 that has a similar arrangement to the frame 10 shown in FIGS. 1-5. A difference between the frame 610 and frame 10 is that frame 610 has an inner lip 622 that is offset from the inner flange 618 and center portion 620 so that the three elements do not form a flat bottom surface like bottom surface 24. The space 623 defined by the offset allows for more flexibility when applying the frame 610 to a clamp C. In other words, the offset space 623 allows for the outer lip 622 to bend and flex when the frame 610 is being turned to fit with the mounting lip L of the mounting clamp C. The space 623 also means that the outer lip 622 is a distance away from the surface on which the frame 610 is supported when the frame 610 is mounted to the clamp C. In other words there is space between the outer lip 622 and the mounting surface when the frame 610 is mounted to the clamp C. The end of the outer lip 622 also extends the same distance as the sidewall 632 of the panel support portion 616, with both features terminating at a border line BL.

The borderline BL can be defined as extending from the edge of the sidewall 632 of the panel support portion 616 in the direction of the lip 622. This is true for other frame embodiments in this disclosure.

FIG. 7 also shows a frame 710. The frame 710 includes an inner flange 718 that includes a rounded end 719. The frame 710 also includes a triangular lip 725 that defines the clamp cavity 726 with the leg 714B. The triangular lip 725 provides a lead-in ramp so that the frame 710 can slide under various mounting equipment in order to facilitate installation. The rounded end 719 and triangular lip 725 may define respective small hollows. If the frame 710 is to be made via extrusion, one having ordinary skill in the art will understand that these features may be modified for easier extrusion.

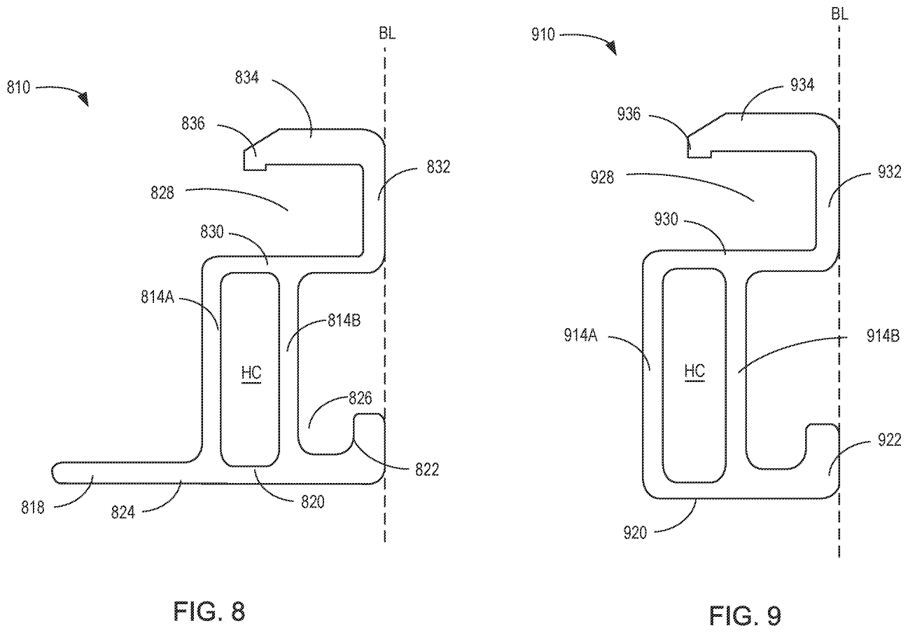

FIG. 8 shows a frame 810 that has legs 814A, 814B extending straight upward from the center portion 820. The frame 810 also has an outer lip 822 that extends straight upward from the center portion 820 parallel to the legs 814A, 814B. The sidewall 832 of the panel support portion 816 and the outer lip 822 are aligned, so that both extend a distance inward and terminate at the borderline BL. FIG. 9 shows a frame 910 that is the same as the frame 810 shown in FIG. 8, except frame 910 lacks an inner flange.

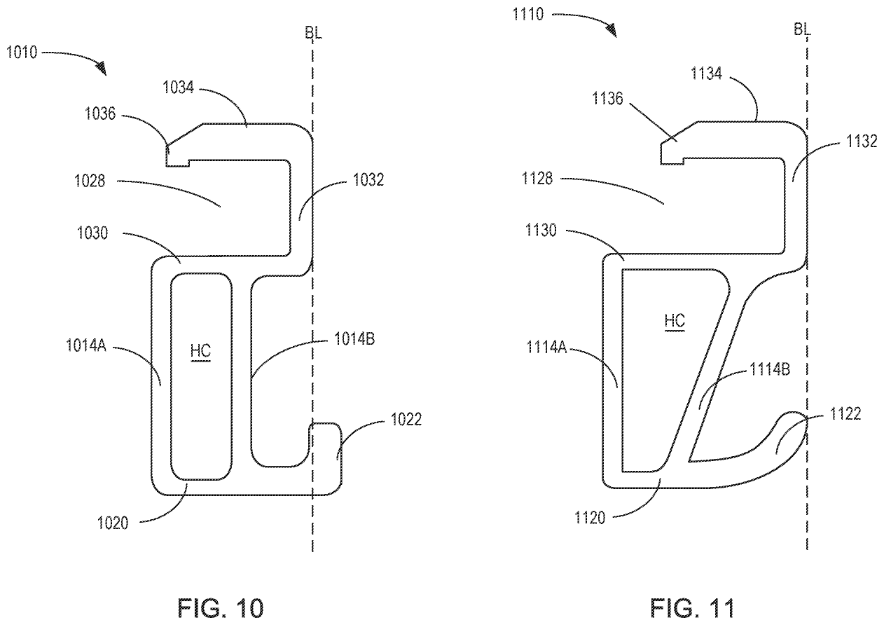

FIG. 10 shows a frame 1010 that is similar to the frame 910 of FIG. 9, in that the frame 910 also lacks an inner flange. However, the outer lip 922 on frame 910 extends beyond the borderline BL defined by the sidewall 932. In other words, the outer lip 922 extends in the same direction as the sidewall 932, but the outer lip 938 extends laterally beyond the sidewall 932 and borderline BL.

FIG. 11 shows a frame 1110 that includes a first leg 1114A that extends straight upward from the center portion 1120 and a second leg 1114B that extends upward at an angle relative to the first leg 1114A. The outer lip 1122 is also curved instead of extending in a straight line. The curved outer lip 1122 shares a borderline BL with the sidewall 1132.

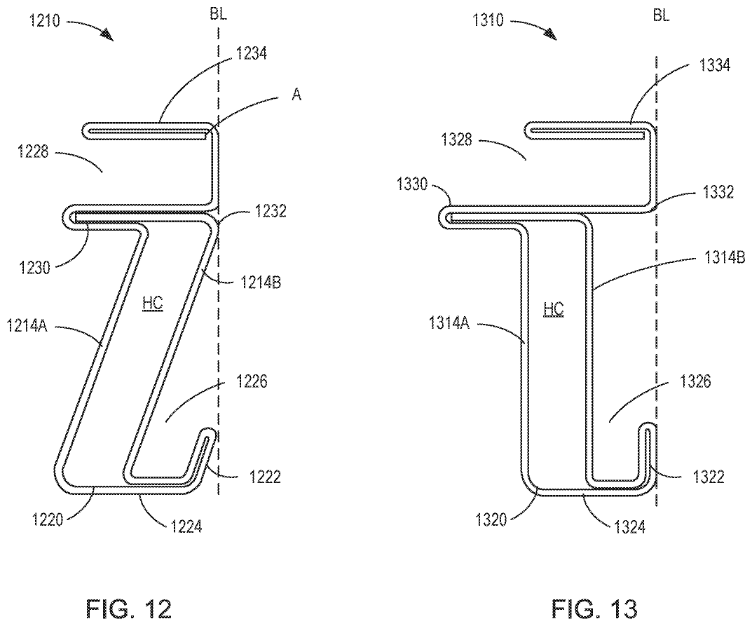

FIGS. 12-17 show frames that are made of roll formed steel. This means that the frames are essentially made of one piece of steel that is folded over on itself to create the shapes shown. FIG. 12 shows a frame 1210 made from a piece of steel that defines a base 1212, legs 1214A, 1214B, and a panel support portion 1216. The base 1212 includes a center portion 1220 and an outer lip 1222 that extends straight from the center portion 1220 at an angle. The legs 1214A, 1214B support the panel support portion 1216 that has a reverse C-shape. The panel support portion 1216 includes a panel support surface 1230, a sidewall 1232, and a topwall 1234. The sidewall 1232 and outer lip 1222 share a borderline BL.

The nature of the roll formed steel means that different parts of the frame 1210 may include one, two, or three layers of steel resulting from the overlapping portions. For example, the piece of steel begins at a starting point A and terminates at end point B. The starting point A is located in the top corner of the panel support portion 1216, where the sidewall 1232 and the top wall 1234 meet. The steel extends in the direction of the solar panel until it is folded over and onto itself so that it forms the top wall 1234. This folding means that the top wall 1234 will be made of two steel layers. After the steel has formed, the top wall 1234 is bent at a 90-degree angle in the downward direction, so that it forms the sidewall 1232. After it forms the sidewall 1232, the steel is bent at a 90-degree angle in the direction of the solar panel, so that it forms the panel support surface 1230. The steel is then folded under itself and then bent downward at an angle to form the first leg 1214A. At the bottom of the frame 1210, the steel is again bent to form the center portion 1220 with a flat bottom surface 1224. From the center portion 1220, the steel is bent upward to form the outer lip 1222. At the top of the outer lip 1222, the steel is folded onto itself again and extends downward until it reaches the center portion 1220. Then the steel extends along the center portion 1020 until it is bent upward and at an angle to form the second leg 1214B. This constant folding means that part of the center portion 1220 and the entire outer lip 1222 are made of two layers of steel. When the steel forming the second leg 1214B reaches the panel support surface 1230, it is bent again in the direction of the solar panel, until it terminates at end point B located within the fold formed in the steel at the end of the panel support surface 1230. This means that the panel support surface 1230 has a first portion that is made up of two layers of steel and a second portion that is made up of three layers of steel. One having ordinary skill in the art will appreciate that the steel folds and bends can be modified to provide additional support in different areas of the frame 1210.

FIG. 13 shows a frame 1310 that includes legs 1314A, 1314B that extend straight upward from the center portion 1320 and an outer lip 1322 that extends straight upward and parallel to the legs 1314A, 1314B. The panel support surface 1330 extends in the direction of the solar panel a distance beyond the end point of the top wall 1334. By comparing the figures, one can see that the extension of the panel support surface 1330 relative to the top wall 1334 is greater than those previously shown.

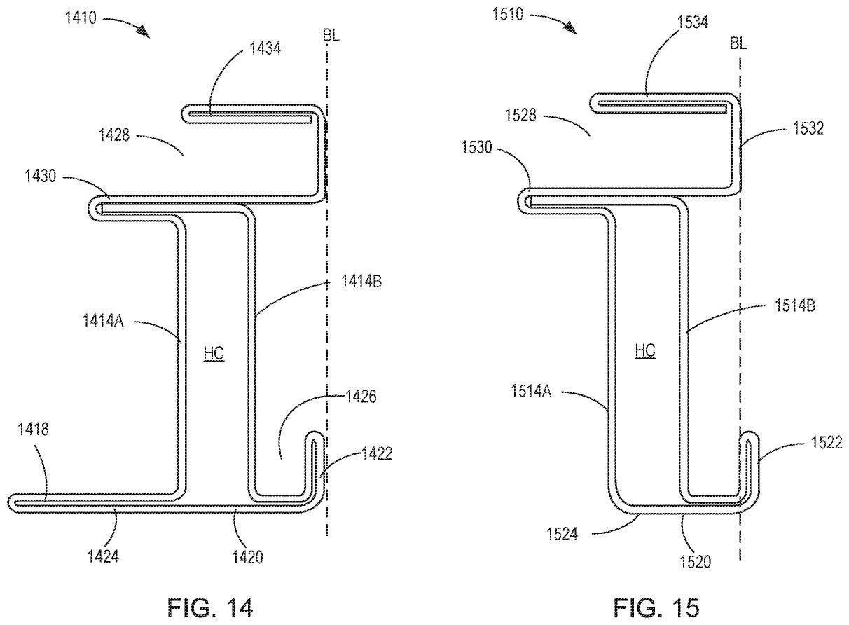

FIG. 14 shows a frame 1410 that includes the features of flange 1410 plus an inner flange 1418 extending beyond the panel support surface 1430. FIG. 15 shows a frame 1510 that includes the features of flange 1110, except the outer lip 1522 extends beyond the borderline BL created by the sidewall 1532 of the panel support portion 1516.

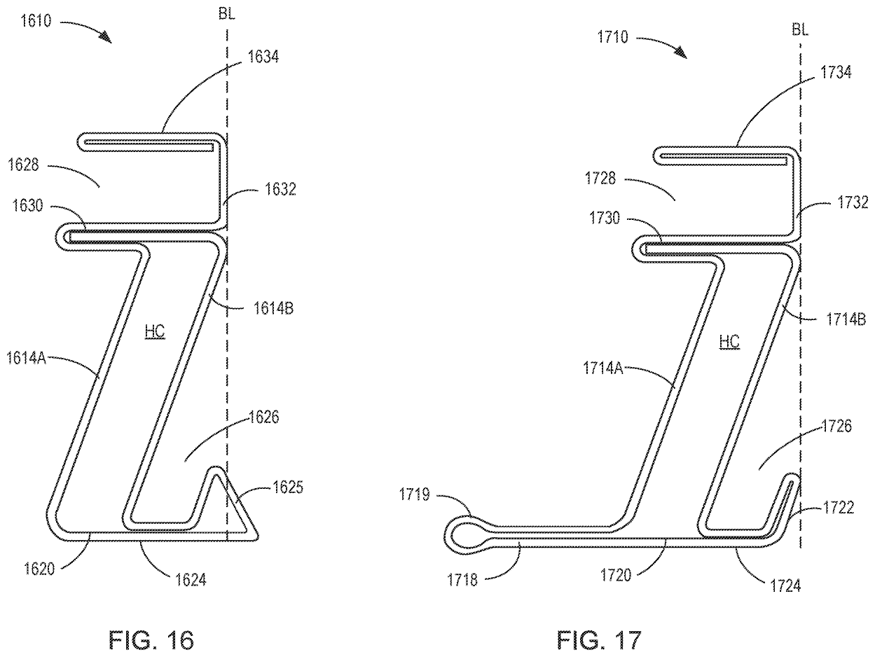

FIG. 16 shows a frame 1610 that has two angled legs 1614A, 1614B and a triangular outer lip 1625. A portion of the triangular outer lip 1625 extends beyond the borderline BL. FIG. 17 shows a frame 1710 with angled legs 1714A, 1714B, an angled outer lip 1722, and a rounded end 1719 at the end of an inner flange 1718. The rounded end 1719 may only be rounded on a top portion of the base 1712 to define a completely flat bottom surface 1724.

While roll formed steel is discussed, it is also appreciated that frames discussed herein can be formed via extrusion.

While specific embodiments of the devices of the present disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the device of the present disclosure which is to be given the full breadth of the claims appended and any and all equivalents thereof.

1. A frame for a photovoltaic module, the frame comprising:
a base portion comprising an outer lip and a bottom surface;
two legs extending from the base portion; and
a panel support portion extending from the at least one leg, the panel support portion configured to secure a solar panel therein,
wherein the outer lip and the at least one leg define a cavity configured to receive a first portion of a solar panel mounting element therein,
wherein the two legs, the base portion, and the panel support portion define a hollow cavity,
wherein at least one of the two legs extend between the base portion and the panel support portion at an angle that is not orthogonal to the base portion or the panel support portion.

2. (canceled)

3. The frame of claim 1, wherein both of the two legs extend between the base portion and the panel support portion at an angle that is not orthogonal to the base portion or the panel support portion.

4. The frame of claim 1, wherein the base portion further comprises an inner flange extending in a direction away from the outer lip.

5. The frame of claim 4, wherein the outer lip is offset such that when the frame is mounted, the offset defines a space between the outer lip and a surface on which the frame is mounted.

6-15. (canceled)

16. The frame of claim 1, wherein the frame is extruded.

17. The frame of claim 1 further comprising roll formed steel.

18. (canceled)

19. (canceled)

20. A method of mounting a frame for a photovoltaic module, the method comprising the steps of:
tilting the frame so as to align a first portion of a solar panel mounting element within a cavity of the frame; and
rotating the frame so that a bottom surface of a base portion of the frame contacts a second portion of the solar panel mounting element,
wherein upon rotation of the frame, the first portion of the solar panel mounting element engages with the frame,
wherein the frame comprises:
the base portion comprising an outer lip and the bottom surface;
at least one leg extending from the base portion; and
a panel support portion extending from the at least one leg, the panel support portion configured to secure a solar panel therein, and
wherein the outer lip and the at least one leg define the cavity.

21. The method of claim 20, further comprising the step of sliding the frame along the solar panel mounting element after the first portion of the solar panel mounting element engages with the frame.

22. The method of claim 21, wherein the first portion of the solar panel mounting element is configured to apply a force to the frame to secure the frame to the solar panel mounting element after the first portion of the solar panel mounting element engages with the frame.

23. The method of claim 20, wherein upon rotation of the frame, the first portion of the solar panel mounting element engages with the outer lip.

24. The method of claim 23, wherein the first portion of the solar panel mounting element contacts the outer lip as the frame is rotated.

25. The method of claim 24, wherein contact between the first portion of the solar panel mounting element and the outer lip creates a sound to indicate engagement between the first portion of the solar panel mounting element and the outer lip.

26. The method of claim 20, wherein the solar panel mounting element comprises:
a rail; and
a clamp,
wherein the first portion of the solar panel mounting element comprises the clamp.

27. The method of claim 26, wherein the second portion of the solar panel mounting element comprises at least a portion of the rail.

28. The method of claim 27, wherein the bottom surface contacts a surface of the rail.

29. The method of claim 20, wherein the solar panel mounting element is configured to mount two frames.

30. A method of mounting at least one frame for a photovoltaic module, the method comprising the steps of:
tilting a first frame so as to align a first mounting lip of a clamp with a cavity of the first frame;
moving the first frame so that a distal end of an outer lip of the first frame contacts the mounting lip; and
rotating the first frame so that a bottom surface of the first frame contacts a portion of a mounting element;
wherein upon rotation of the first frame, the first mounting lip is at least partially received within the cavity and engages with the outer lip,
wherein the first frame comprises:
a base portion comprising the outer lip and the bottom surface;
at least one leg extending from the base portion; and
a panel support portion extending from the at least one leg, the panel support portion being configured to secure a solar panel therein, and
wherein the outer lip and the at least one leg define the cavity.

31. The method of claim 30, wherein the first mounting lip is configured to apply a force to the first frame after the first mounting lip engages with the outer lip.

32. The method of claim 30, wherein the outer lip and the first mounting lip are configured to create a sound when the first mounting lip engages with the outer lip.

33. The method of claim 30, wherein the mounting element comprises a rail, and
wherein the bottom surface contacts a surface of the rail.

34. The method of claim 30, further comprising the steps of:
tilting a second frame so as to align a second mounting lip of the clamp with a cavity of the second frame; and
rotating the second frame so that a bottom surface of the second frame contacts a portion of the mounting element,
wherein upon rotation of the second frame, the second mounting lip is at least partially received within the cavity of the second frame and engages with an outer lip of the second frame.
